(19) United States
(12) Patent Application Publication
(10) Pub. No.: US 2007/0094044 A1
(43) Pub. Date: Apr. 26, 2007

(54) Web based health and wellness resource locator

(75) Inventors: Jeffrey L. Stone, Brentwood, TN (US); J. Eric Hendrickson, Hendersonville, TN (US); Stuart McCloy, Lexington, KY (US); David A. Young, Franklin, TN (US); Quinetta Long, Hendersonville, TN (US)

Correspondence Address: WADDEY & PATTERSON, P.C., 1600 DIVISION STREET, SUITE 500, NASHVILLE, TN, 37203, US

(73) Assignee: EMD 24-7 DEVELOPMENT, LLC, BRENTWOOD, TN (US)

(21) Appl. No.: 11/050,491

(22) Filed: Feb. 2, 2005

Related U.S. Application Data
(60) Provisional application No. 60/541,138, filed on Feb. 2, 2004.

(51) Int. Cl. G06Q 10/00; G06F 17/30

(52) U.S. Cl. 705/2; 707/3

(57) ABSTRACT

The current system can include user-initiated, system-prompted and sometimes human-assisted consumer access to specific filters within the automated system. These filters can direct the consumers/patient to a rank ordered list of various health and wellness providers that are relatively available. This list can be segmented by various criteria that are ranked however the consumer chooses. These can include providers that are within the specific health plan or under the insurance coverage or previous pay arrangement of the consumer, or by geographical or zip code locations, and various other optional criteria, including, but not limited to, ethnicity, language, proficiency, gender, experience level, specialization, and the like. The consumer can schedule a consultation/appointment/visit on the appointment schedule of the provider of the consumer's choice after reviewing the options available.

### CROSS-REFERENCES TO RELATED APPLICATIONS

This application is a Non-Provisional Utility application which claims benefit of co-pending U.S. Patent Application Ser. No. 60/541,138 filed Feb. 2, 2004, entitled “Web Based Health and Wellness Resource Locator” which is hereby incorporated by reference in its entirety.

A portion of the disclosure of this patent document contains material that is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

The present invention relates generally to user interactive World Wide Web based marketing and transactional management services for multiple categories of providers and vendors of healthcare, wellness, and healthy lifestyle services and products. More particularly, this invention pertains to an internet based service for providing healthcare and wellness information coupled with facilitating healthcare and wellness solutions for users of the service to address specific heath related issues, including the establishment of future services and products from the healthcare and wellness providers to the users of the internet based service.

Access to healthcare, at all levels of activity, in all clinical, demographic, and payer segments, continues to present both major challenges and opportunities to all participants in the continuum of care.

Consumers of health care products and services face confusion and roadblocks to accessing appropriate providers in timely, geographically correct, and payer-correct patterns. These patterns are ever-evolving, changeable without notice: providers' status changes, care delivery sites change, new sites are created, providers consolidate and undergo name changes, and operations are terminated without notice.

Compounding this shifting scheme, health plans redraft their lists of qualified/inclusion physicians, change payment rules daily, rewrite permission rules for admittance/access, and also recreate entire new rubrics as health plans merge, terminate, and otherwise redirect patients. Would-be patients move about the matrix of care delivery as they change employers, relocate their homes, face uninsured interludes, add family members, age, and encounter new clinical risks and events.

Surprisingly, very little system support or access optimization has been designed to impart efficiency in the patient distribution channel. No added speed, fluidity, or accuracy has been imparted to the process of connecting qualified consumers with qualified providers of care. Further, no system deployment has been attempted to provide these benefits individually or collectively on an industry wide or national level. Considering the acknowledged importance of “gate keeping” of patients to cost containment initiatives, and also considering the commercial power available to those who “gate keep,” it is disappointing how little progress has been made in organizing and steering patient flow beyond simple local telephone referral networks, print advertising, and payer formularies (rationing mechanism)-all formulated and managed on local market levels by selected provider networks, all containing varying levels of error, obsolescence and utility.

This profound void of market efficiency has perpetuated an endless shuffling of provider assets in random, reactionary configurations to attempt “catch-up” patterns of deployment as consumers of care move about the matrix. Analogous to retail store relocation in a shifting retail environment (while consumers are online in increasing numbers), this is an expensive and arcane distribution methodology. Examples include hospitals' sponsorship of satellite walk-in clinics (with varying success), physicians' practice consolidations and PPM formations, HMO sponsored/captive clinics (failure), and similar channels. Suppliers and distributors of products, ancillary services, and related have struggled in expensive ways to reconfigure distribution in parallel, resorting to “stockless purchasing” programs, and unorthodox shipping methods.

Consumers have experienced multiple disconnects and reconnects with providers in a non-systematic way and without efficient choice models. Ultimately, excess market fluidity caused by provider and payer restructuring of the industry since 1980 has superceded and outpaced distribution channel efficiencies for healthcare. Currently, online catalogues and list of choices available on a real time basis for anyone seeking an immediate physician appointment, a dental appointment, or a psychologist to deal with a crisis are lacking. Said another way, there is little hope for a potential consumer of care to learn easily and quickly which provider is available and at the most convenient hour and date, at the price (payer approved list, etc.) required. Likewise, and even more importantly, the current art lacks a way for a consumer to actually view several available options, make a choice, and select/confirm an appointment in an immediate sense.

This lack of distribution is correctable, and system solutions envisioned via the enclosed invention could revolutionize consumption of healthcare. A virtual, digital distribution channel is possible.

The efficiencies and empowerment of buyers available through the current invention can measurably change the entire industry. Buyers typically want choices, they want comparison shopping benefits, and they want speed and closure in transactions. The proposed Medicare voucher system represent further indication that consumer empowerment in the healthcare is a real trend by the current politic.

This profound void of market efficiency in the healthcare industry can be filled adequately by the current invention. As such the current invention provides a needed and economically viable solution to this problem. Clinical and economic benefits are available to and can accrue to all participants in the chain of healthcare distribution, from consumers to providers, payers and suppliers through optimization of the “Access to Care Transaction.”

The “Access to Care Transaction” can be described as the ability for individuals to establish, at a minimum, knowledge of the closest care givers, in both traditional and non-traditional medical healthcare fields, for specific healthcare and wellness issues which that person may have. Additionally, “Access to Care Transaction” can include the ability of the individual to identify providers of healthcare services and products that handle specifically health issues and even schedule consultations, or deliveries, from these particular healthcare providers. Unlike other existing internet based systems that are based on providing medical information, the current invention substantially focuses on the Access to Care Transaction.

Some of the value created by the current invention can include time recapture of provider services, attempted provider appointment efforts however executed, and recapture of energy expended qualifying payer permissions and approvals. Transaction efficiency and value can also result from enabling multiple other buyer selection criteria (gender of the provider, language spoken, practice facilities, methodologies, and philosophies, institutional affiliations, hospital admission staff membership, group practice affiliation, etc.). Byproducts of a fully functioning and widely subscribed system, as disclosed, includes some obvious advantages available to many major distributors in assorted commercial markets. Directing patient flow is a preference of most every institution in healthcare. However, hospitals have little if any influence beyond their local clinical image. Enabled patient flow via system efficiencies provides a pathway and platform to generate additional commercial applications and cash flows.

What is needed, then, is a system for providing users of the system access to health related information as well as an easy, effective and effective method of establishing access to services and products that fall within the users' specific criteria.

### BRIEF SUMMARY OF THE INVENTION

Disclosed herein is a method of providing healthcare related information to a user. The method comprises establishing a database of health related service providers, gathering information from the user, and processing information to determine a health-related need. The health-related need is matched to the database of health-related service providers and a user-specific list of health-related service providers is created based upon the health-related need and the information gathered from the user. The list of health-related service providers is provided to the user and the user is allowed to pick a specific health-related service provider. The method teaches scheduling a consultation between a user and a specific health-related service provider.

The method further includes using interactive software to gather the user's health-related information, the user's geographical information, and the user's preference information. The user's preference information can include the gathering of the user's language preference, insurance coverage, and gender preference. Additionally, the interactive software can be used to process the information from the user in order to determine the health-related need. As such, various pieces of information can be gathered from the user and utilized to determine a health-related need for that user which can vary according to the specific information and additional details collected during this discovery process.

Preferably the information gathering, processing, matching, and scheduling of the consultation are performed by a real time interaction between the user and the database across the internet. A user can access various web pages supported by a web server. The web pages can access the database of health-related service providers as well as additional health-related information designed for certain fact situations as determined from the information gathered from the user.

The consultation established between the user and the specific health-related service provider can include establishing an appointment or visit between a user and the health-related service provider. Additionally, this consultation can include the ordering of products or services from the health-related service provider by the user.

Also disclosed is a method of utilizing the internet to provide a user with healthcare-related information and establishing a consultation between the user and a healthcare-related service provider. The method comprises providing a web server associated with the database of health-related service providers and allowing the user to access web pages supported by the web browser. Additionally, interactive software is used to establish a user directed health-related need and to gather user specific information. The user is provided with healthcare-related information corresponding with the health related need and a user specific list of health-related service providers is created by comparing the health-related need and the user specific information to the database of health-related service providers. The user then can select a specific health-related service provider. The method teaches scheduling a consultation between the user and the health-related service provider chosen by the user.

In a preferred embodiment a substantially anatomically correct human image can be used to establish the user directed health-related need. This human image can also be described facilitating the collection of user specific information which can include the user's symptoms, age, gender, and geographical location.

The health-related service providers can include traditional medicine providers and non-traditional alternative therapies. These providers and therapies can include doctors, nutritionists, therapists, counselors, trainers, medical device suppliers, pharmacists, gymnasiums, acupunctures, and holistic medicine providers.

The method further includes accessing a computer based scheduling system of the specific health-related service provider and reserving a consultation between a user and a specific health-related service provider. Additionally, the system can obtain a consultation deposit from the user to facilitate attendance of the user at the consultation.

The method also includes providing the user with service provider information on various health-related service providers that appear on the user specific list of health-related service providers.

The method can further include using a contact center to answer questions from the user. This contact center can include a computer based interface between the user and a contact center, or a telephone interaction between the user and the contact center.

Also included is a navigational system for providing health-related information to and scheduling services for a user of the internet. The system comprises a web server containing a database of healthcare-related information, a retrieval system accessible by a user of the internet, and a scheduling system interfacing a user of the internet and a healthcare-related service provider. The database includes a list of healthcare-related service providers, service provider information specific to each of the healthcare-related service providers, and healthcare-related information specific to a plurality of healthcare-related needs. The retrieval system includes an interactive interface between a user of the internet and the web server. The scheduling system includes interface between the user of the internet and the healthcare-related service provider to establish a consultation between the user of the internet and the healthcare-related service provider.

Approximately 55% of America's internet users, or 5.5 million people on a typical day, search the internet for health-related information. Furthermore, at least half of Americans have expressed dissatisfaction with availability of, or duration of meetings with their physician, according to a recent report. The current invention provides more than the usual offerings of endless list of links to articles, institutions, organizations, news, advertisements, chat rooms, and etc. currently available on the World Wide Web. The current invention can base interactions on the users' symptoms, need, age, gender, and geographical location. Within the system, proprietary medical information can be presented in a compelling, condensed, and highly focused manner. The information provided includes action options which cover a wide spectrum of provider categories from traditional medicine to non-traditional alternative therapies, as well as services and products related to wellness and healthy lifestyles.

The current invention offers multiple benefit and/or product opportunities for healthcare distribution channel participants. On a conceptual level, efficiencies can accrue to the various participants in the transactional process. For example, there can be four major areas of participants within the known healthcare distribution systems; consumers, or users, providers, suppliers, and payers. The providers can include physicians, ancillaries, intermediaries, agencies, and institutions in the health and wellness areas. The suppliers that can benefit include suppliers of specific products, such as prescriptions, devices, and other specific medical supplies, as well as suppliers of pre and post care services, home health care services, rehabilitation, counseling and, bereavement. The list of payers that can benefit from this invention includes employers, insurers, managed care organizations systems, Medicare, and cash and voucher programs. The various payers can engage in specific actions and specific price points with specific expectations that are personal and event related. For example, the various payers can use the current invention provide restrictions or warnings to a user of the invention when a provider or supplier falls outside of the payers preferred network.

Through the use of the flexible structure, the switching platform of the current invention, and the ability to enable multiple future inputs and outputs to the access to care transaction, an increased overall value to participants of the system can be attained. The current system can be revised and repositioned over time to achieve additional product development and deployment of specific health and wellness users and suppliers while still maintaining the core ideal of the access to care transaction.

The current system can include user-initiated, system-prompted and sometimes human-assisted consumer access through specific filters within the automated system. These filters can direct the consumer/patient to a rank ordered list of various health and wellness providers that can be available to him/her. This list can be further refined by various options that can be ranked however the consumer chooses. These can include providers that are within the specific health plan or under the insurance coverage or previous pay arrangement of the consumer, or by geographical or zip code locations, and various other optional criteria, including, but not limited to, ethnicity, language, proficiency, gender, experience level, specialization, and the like.

The consumer can schedule a consultation/appointment/visit on the appointment schedule of the provider of the consumer's choice after reviewing the options available. This can occur by interface within the invention's software and databases to the scheduling system of the provider of the services that are affiliated with the database. The consumer can also schedule institutional provider services, including various imaging, mammography, lab work, rehabilitation, admittance, surgical procedure, and the like. The consumer can also order products such as DME, diabetic supplies, prescriptions, home health care services, medical devices, and the like, as well as check nursing home availability and assisted living vacancies. The current invention can use a patient's/consumer's transaction records to select third party administrators for the specific patient/consumer. The consumer can also request intervention by local social services or a transfer of medical records to new facilities as well as a scheduling of ancillary health services including dental, orthodontic, ophthalmologic, counseling, bereavement, funereally, legal assistance, and other similar ancillary health and wellness services.

The current invention separates itself from other internet, or online, health and wellness services in several ways. First of all, the current invention goes beyond a simply relay of information on health issues available through general clinical and encyclopedia and medical information search engines, as well as simple triage advising/assisting, and self-diagnosis. This is due to the fact that in the current invention, specific health and wellness issues pertinent to the users can be developed to lead the consumer to the health and wellness providers to best address the users' needs. The current invention also goes beyond unqualified provider search engines based on the “yellow pages” by a specifically matching, on an interactive data base through a series of well established medical criteria, the users' issues to specific health related needs/issues and corresponds those needs/issues to specific health and wellness providers that should be best to address and handle the health and wellness needs/issues of the consumer.

The current invention can establish and employ a computing server platform capable of capturing and processing consumer access inputs, for example, up to several million per week. The computer platform can process and direct consumer queries in real time, as well as subscribe, screen, and qualify provider targets. Once matched, consultation attempts, such as appointment scheduling, can be made by the consumer through the current invention by the computer server processes to connect to the provider's computer based scheduling system, such as appointment book software. Direct feedback to the online query, or consultation attempts, is possible to the consumer through real time confirmations. Alternately, the consumer can be contacted directly through various means, including telephone, email, and the like. The consumer can also have the choice of directly contacting contact center personnel to assist in selecting and booking a provider of the health services given the elected screening criteria entered by the consumer. This contact can be through direct electronic connection or telephone connection.

A consumer visitor seeking health information in the system of the current invention can use compelling graphics and authorative original content intentionally designed to be concise and relevant to his/her specific interests. The contents can be based on symptoms, such as headache, and area of interest, such as weight loss or fitness, rather than specific diseases. The information content can lead the user to the database with subscribed providers whose individual contact information can be posted in the system of the current invention, and whose businesses are ideally located within the visitor's zip code area. The subscribed providers of products and services can establish the information on the database from which a visitor can use the specific filters on the host invention website to find a provider that ideally specifically handles the health and wellness issue of concern to the visitor.

Connectivity, access, convenience, and simplicity to a visitor/user of the current invention can be some of the basic features. The user can visit the site and find out what to do and where to go, in their own neighborhoods, for specific goods and services, relating the their health questions and healthy lifestyle interest. The users can then match up with specific providers, or clients of the system, wherein the user can seek to purchase specific types of services and products in his/her geographic areas.

Some novel aspects of the invention can include 1) a multi-layered three dimensional anatomic mannequin used within the entry portal as an initial filtering element of the data; 2) succinct, authorative (peer reviewed) proprietary informational content; 3) simplicity of a point and click pathway using information requested from the individual user; 4) a national database of subscribed resource providers; 5) directing users to the specific business locations of the providers; 6) appointment scheduling; and 7) a nurse-staffed call center linked to the website user to render real time personal and professional assistance.

It is therefore a general object of the present invention to provide a web based system to connect users of the system to providers of health and wellness products and services to specifically address the health and wellness issues of the users.

Numerous other objects, features and advantages of the present invention will be readily apparent to those skilled in the art, upon a reading of the following disclosure, when taken in conjunction with the accompanying drawings.

### BRIEF DESCRIPTION OF THE SEVERAL VIEWS OF THE DRAWINGS

FIG. 1 is one embodiment of the interactive mannequin that can be used as an initial filtering for the current invention.

FIG. 2 shows an example of a second level of filters that can be used to be specifically to direct a user of the website into specific areas of the body in which he/she has concern.

FIG. 3 shows an example of a third filter that can be accessed by users of the website to direct the user to more detailed causes and solutions for a specific health need.

FIGS. 4A-4G shows an example of various sub-filters used to guide a user of the invention into specific health and wellness needs and provide general information and possible solutions to address the need.

FIGS. 5A-5B shows one example of interactive software used to create a listing of health related service providers based upon specific criteria selected by the user.

FIG. 6 shows one example of a provider list given to a user of the system where a critical health issue could be the cause of concern of the user.

FIGS. 7A-7E show one example of a listing of specific resource providers as determined from the input criteria of a user of the system.

FIG. 8 shows a schematic example of one embodiment of a method of the disclosed invention.

FIG. 9 shows a schematic example of an alternate embodiment of a method of the disclosed invention.

FIG. 10 shows a schematic example of the system flow for an embodiment of a method of the disclosed invention.

FIG. 11 shows a schematic example of the interface between various components of the current invention.

### DETAILED DESCRIPTION OF THE INVENTION

The current invention can be generally described as a healthcare access enablement system providing levels of real time connectivity between participants in the chain of healthcare delivery. The current invention is preferably an Internet based interface between consumers, or Internet users, and providers of services and products in healthcare and related industries. Additionally, the current invention can provide specific health and wellness information related to specific health and wellness needs of the user. The invention can be described as being accessed and driven by the user/consumer, as opposed to a service provider driven system.

In a preferred embodiment, the current invention provides a health and wellness resource locator for a user. The resource locator can be described as a database of subscribing providers in or near the user's geographical area with training, expertise, interest, or products that are relevant to the user's symptoms or needs. Also available is a specific interface between the subscribing providers scheduling systems and the current invention to allow users of the invention to establish a scheduled appointment or meeting with the healthcare or wellness care provider so that the health need or symptom of the user can be addressed. A contact center can also be included. The contact center can use trained professionals to assist users in making appropriate choices and facilitate the booking of appointments with providers. The appointment scheduling and contact center interactions are preferably real-time online interactions.

Functionally, the current invention enables consumer access to multiple alternatives for care, and creates specific transaction events, within the scheme and boundaries of the consumer's own selection criteria. Parameters such as zip code, preferred appointment date and time, numerous qualitative dimensions or characteristics of a provider or supplier, transaction assistance and interactive models are examples of consumer empowerment or value added services available through the current invention. Consultations can be scheduled as the invention manages the search, display, selection, and booking process. Additionally, the invention can confirm appointments, facilitate advance registration steps with providers, manage the commitment deposit for appointments process, and schedule follow-up calls to the patient for post-appointment case management purposes. Tailored information downloads are distributed to the user pre-appointment in order to inform the user/patient about clinical considerations, and to assist him/her in the appointment event (what to ask, what to bring, etc.).

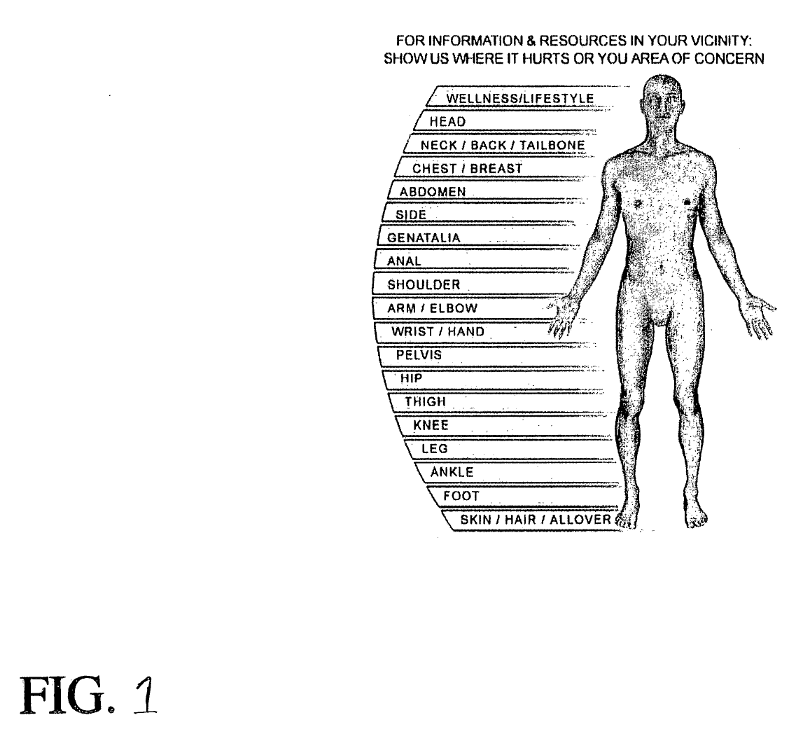

The current invention can operated substantially as follows. From the web based homepage, the visitor/user can be shown a uniquely creative and compelling multi-layered three dimensional anatomic mannequin, as exampled in FIG. 1, from which to choose a specific area of interest. The user can choose from various other areas on the home page, such as instruction on a proper medicine chest, home safety, and how to use the site. The anatomic mannequin can be one of the first filters used in the site to direct a user a specific area of interest, determine a health related need, and match up the user's need to a specific provider of health and wellness services or products.

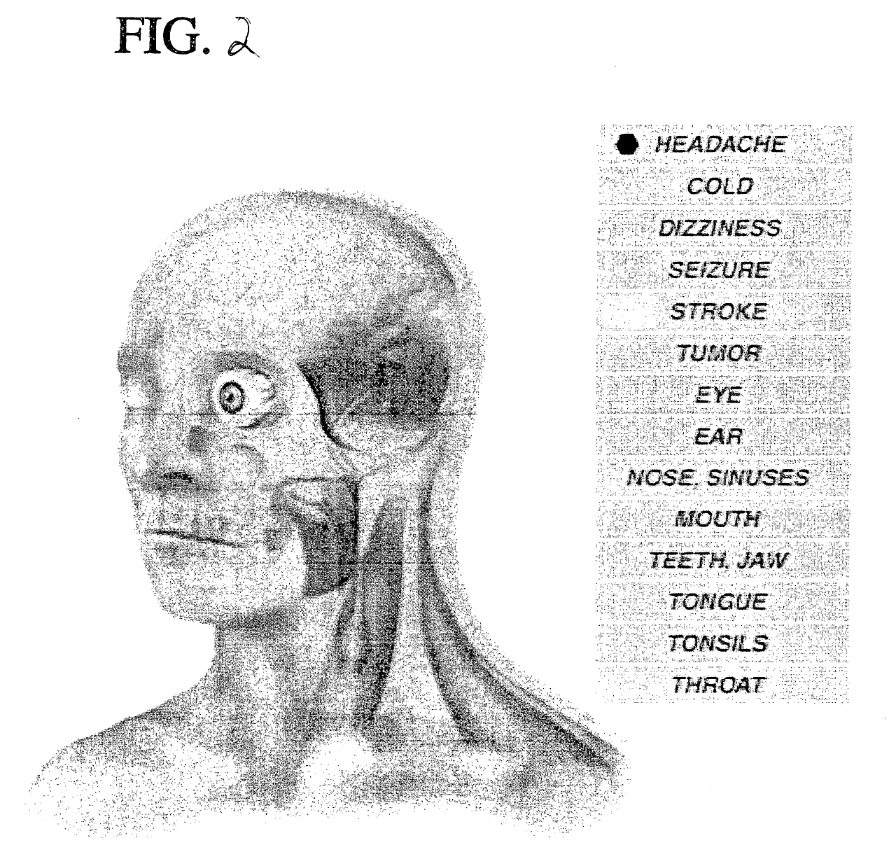

Next, a symptom menu appears and establishes a second line of filters which show various symptoms to the anatomic location chosen by the user, as seen in FIG. 2. A user can then decide the main symptom he/she is experiencing, or he/she can visit multiple symptoms within the system.

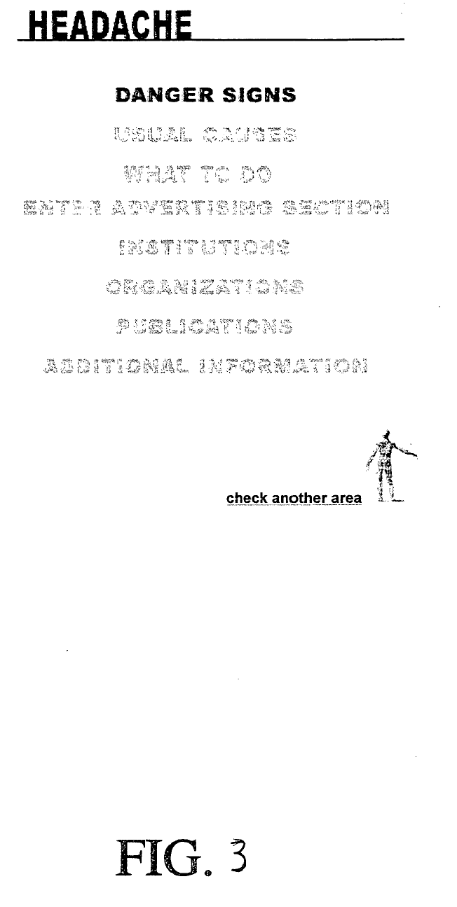

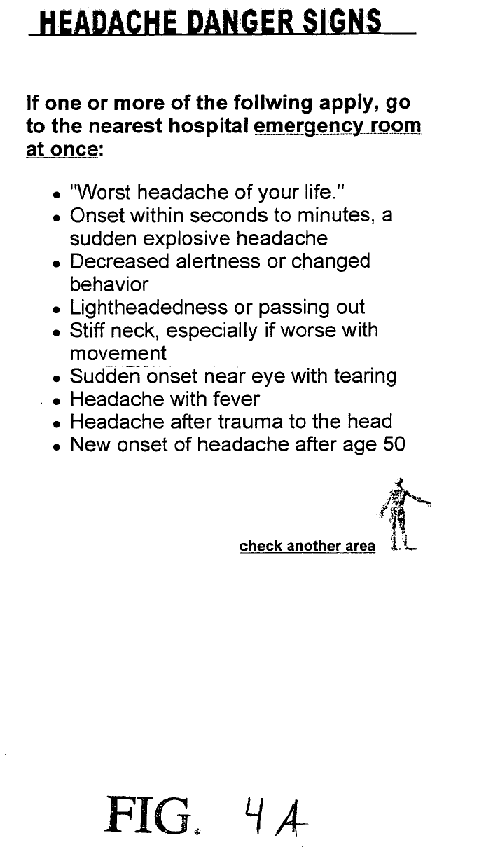

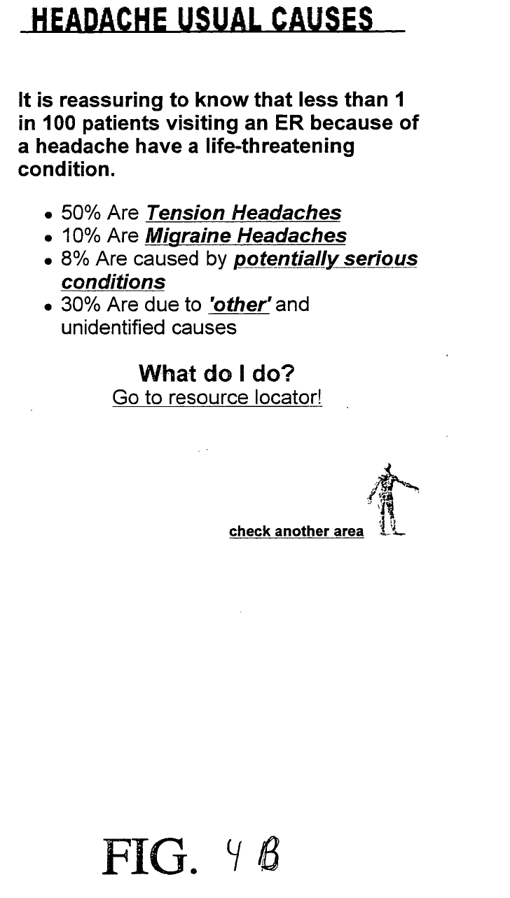

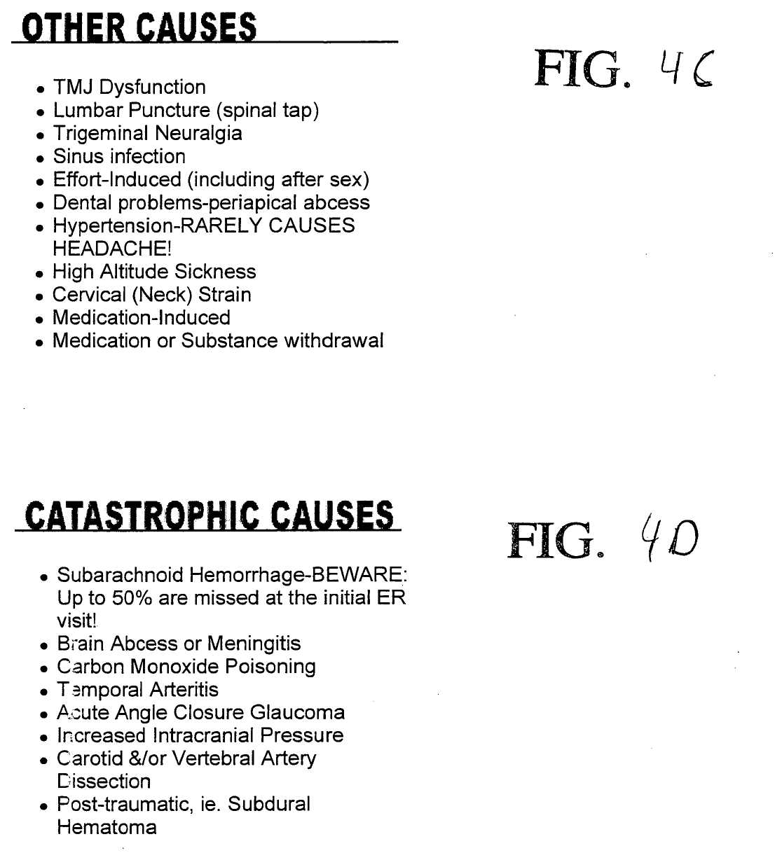

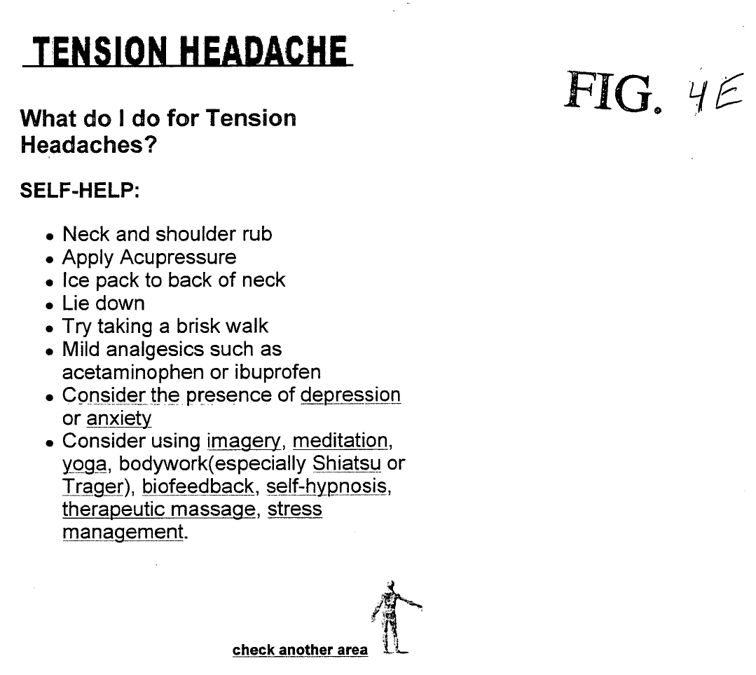

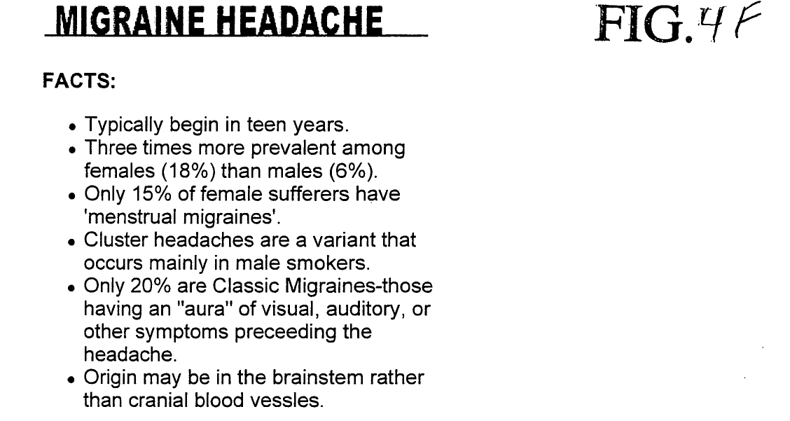

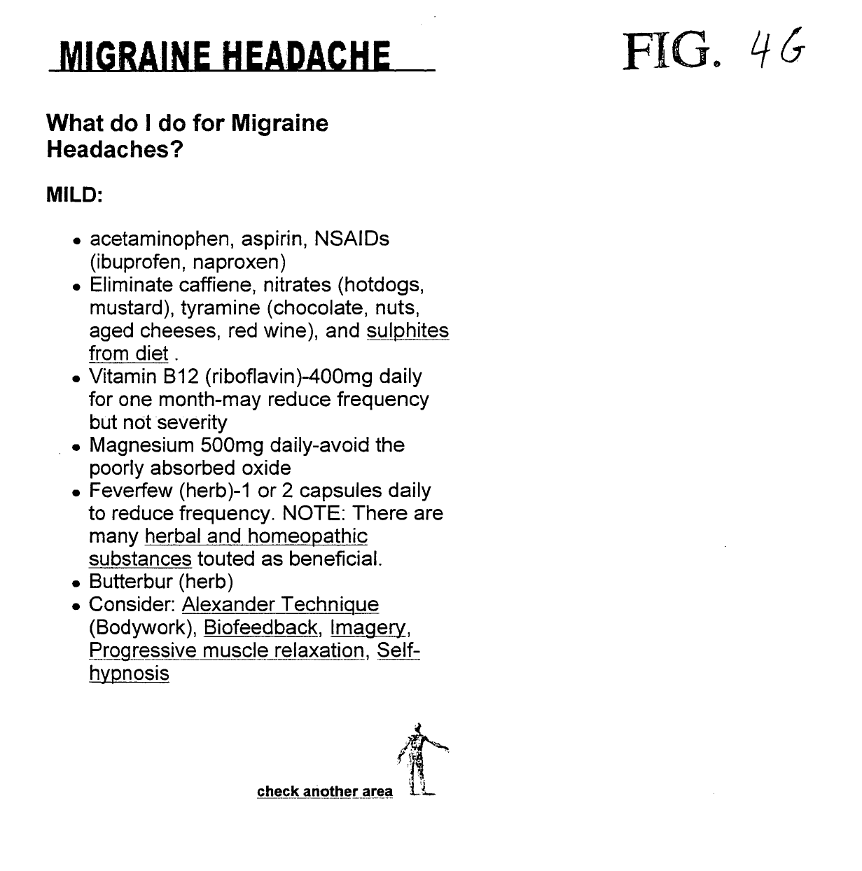

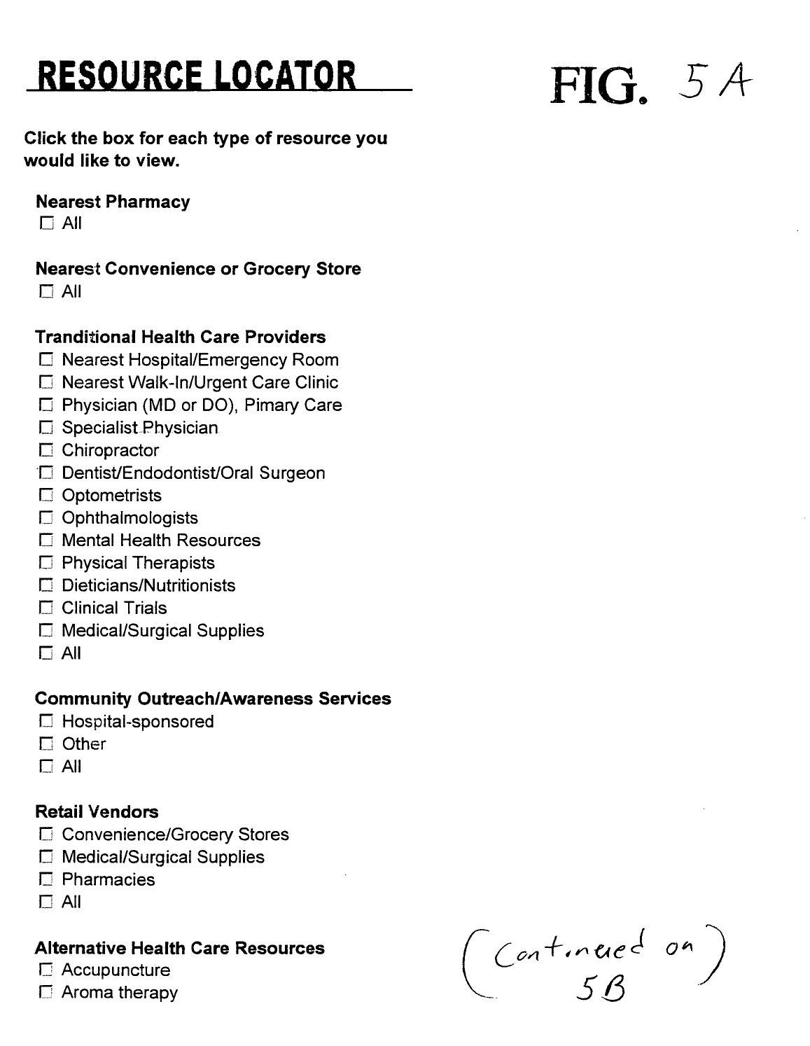

Next, a third filter level, as seen in FIG. 3, can allow the user to select from various amounts of proprietary medical information which can include danger signs which would warrant immediate medical attention through usual causes of the symptom experienced by the user. This level of filter can include various levels of information and connections to other sources of information, as warranted, addressing the symptoms experienced by the user. These can include danger signs, usual causes, and what to do options. These various amounts of information are exampled in FIGS. 4A-4G.

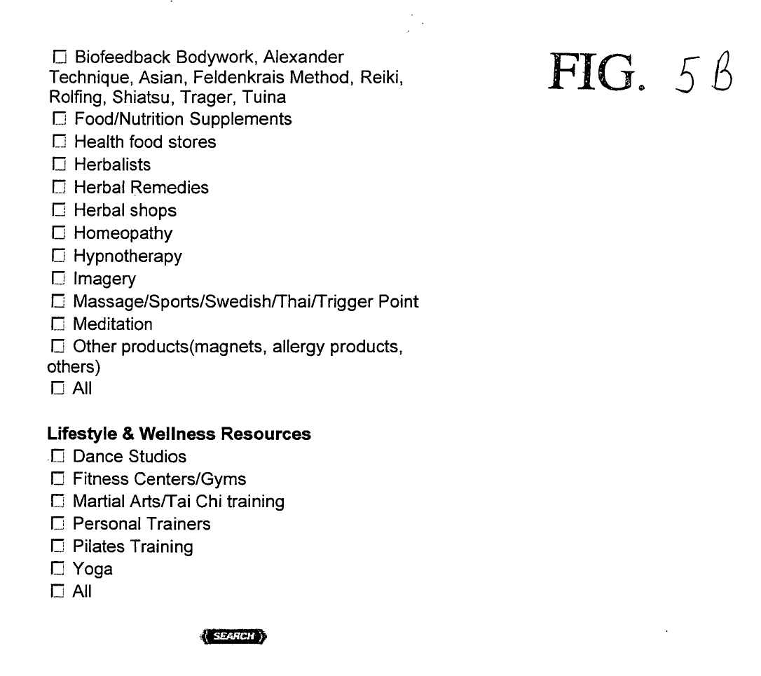

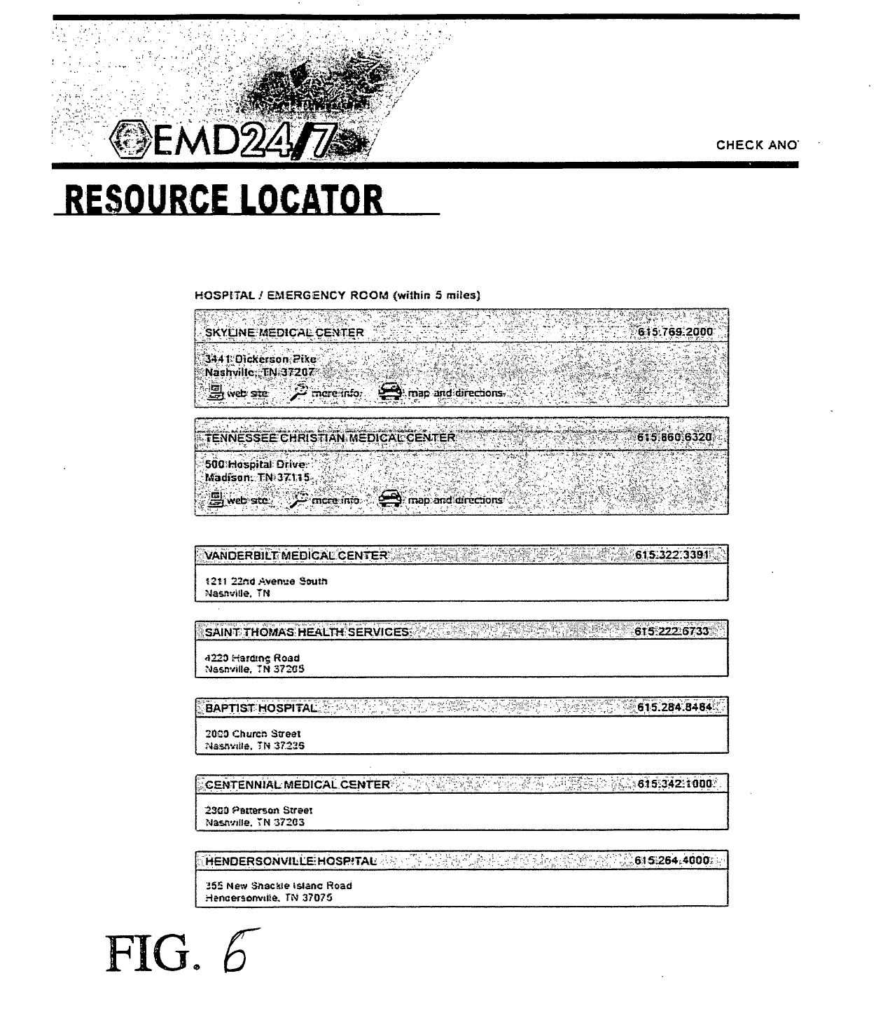

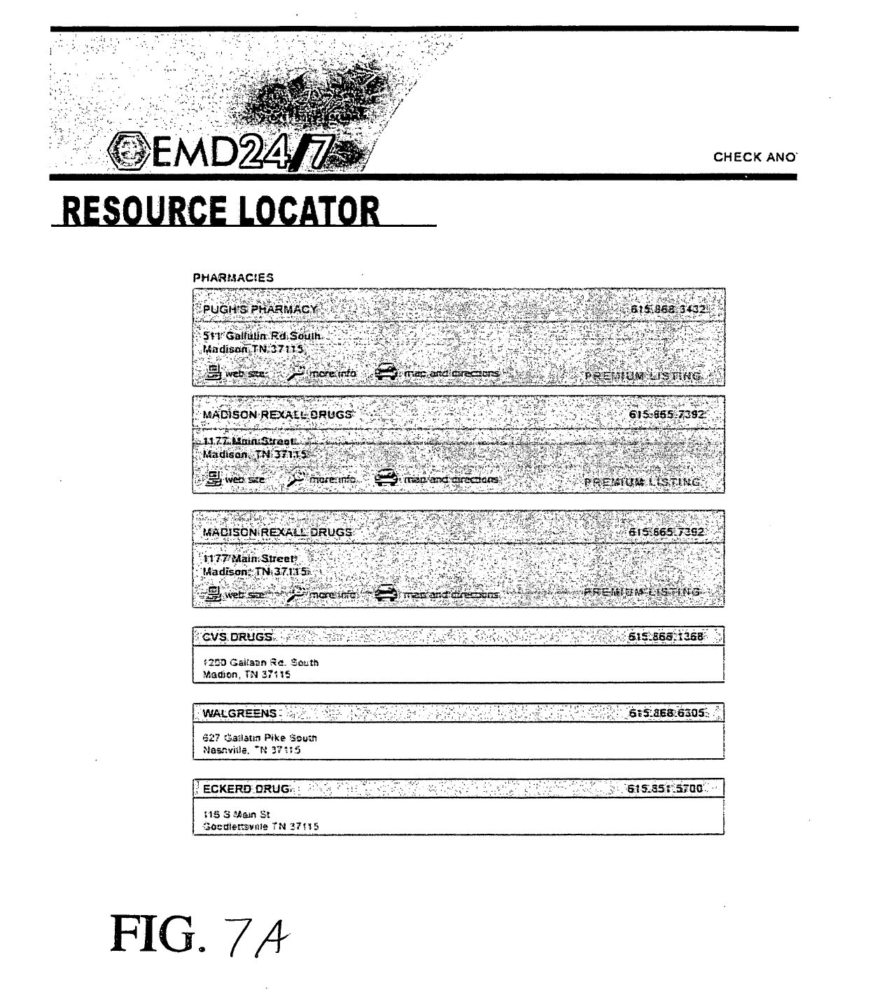

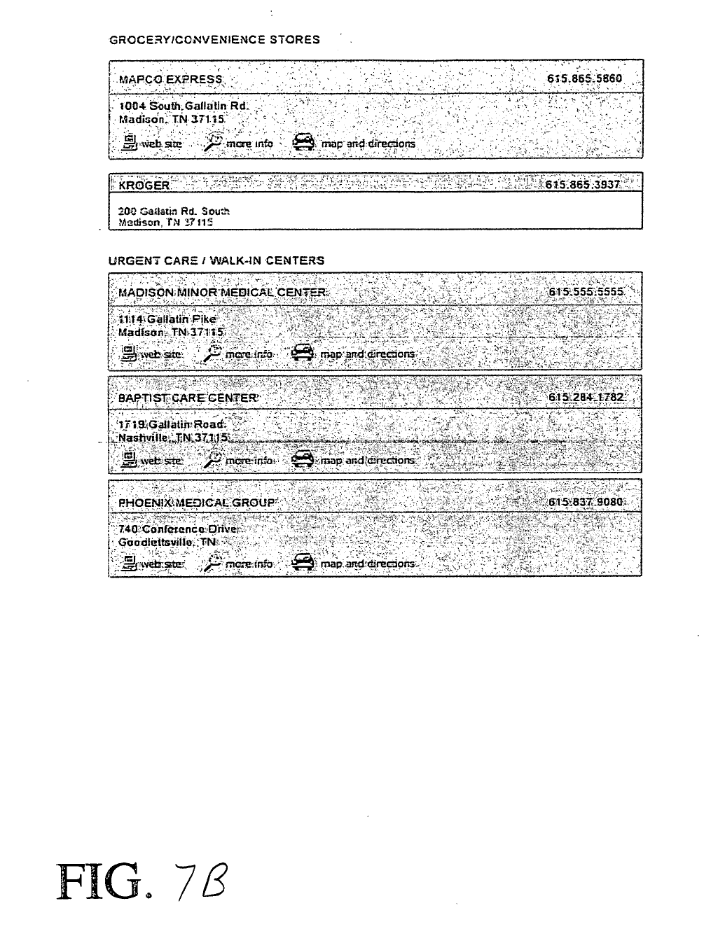

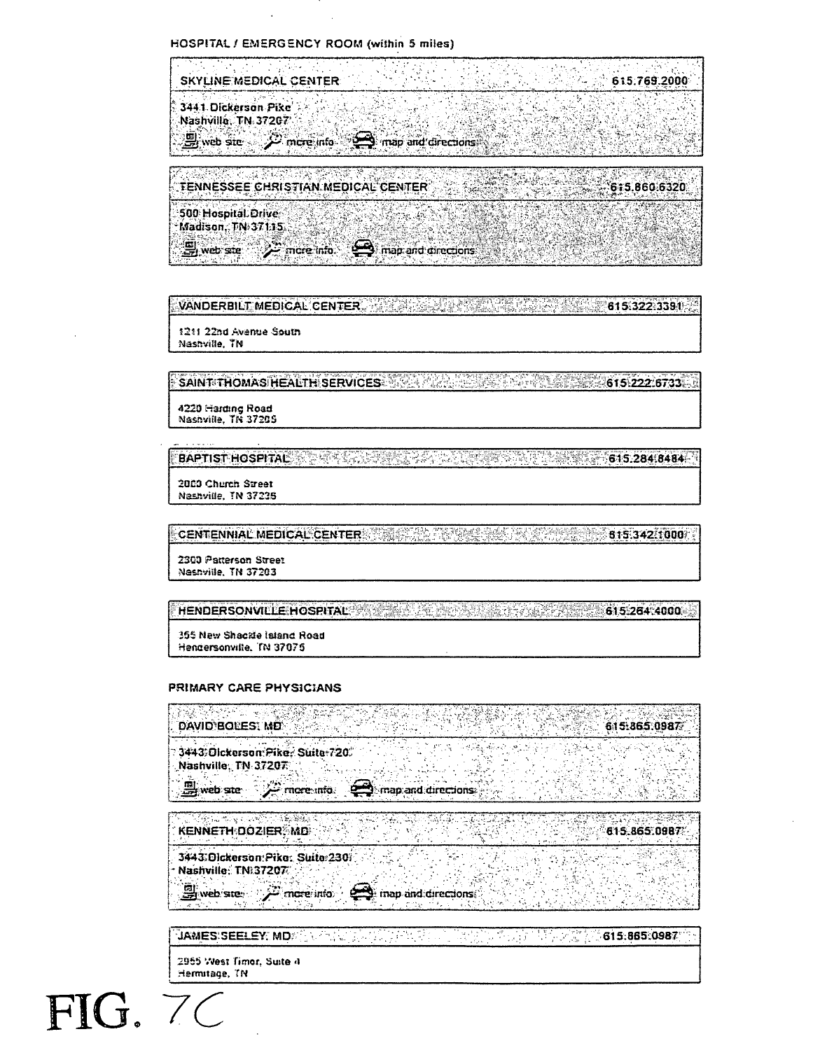

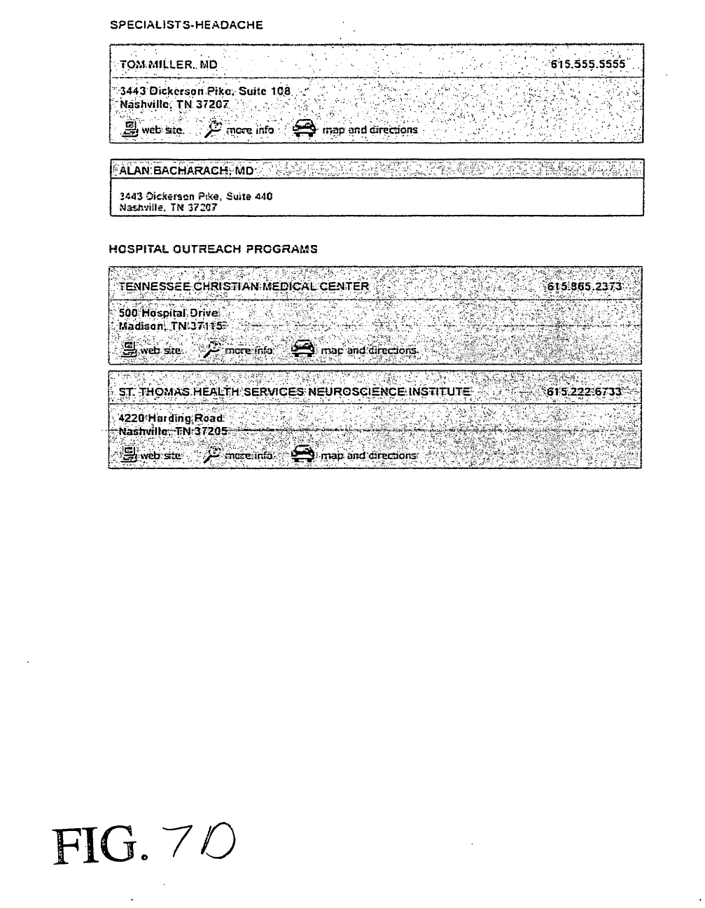

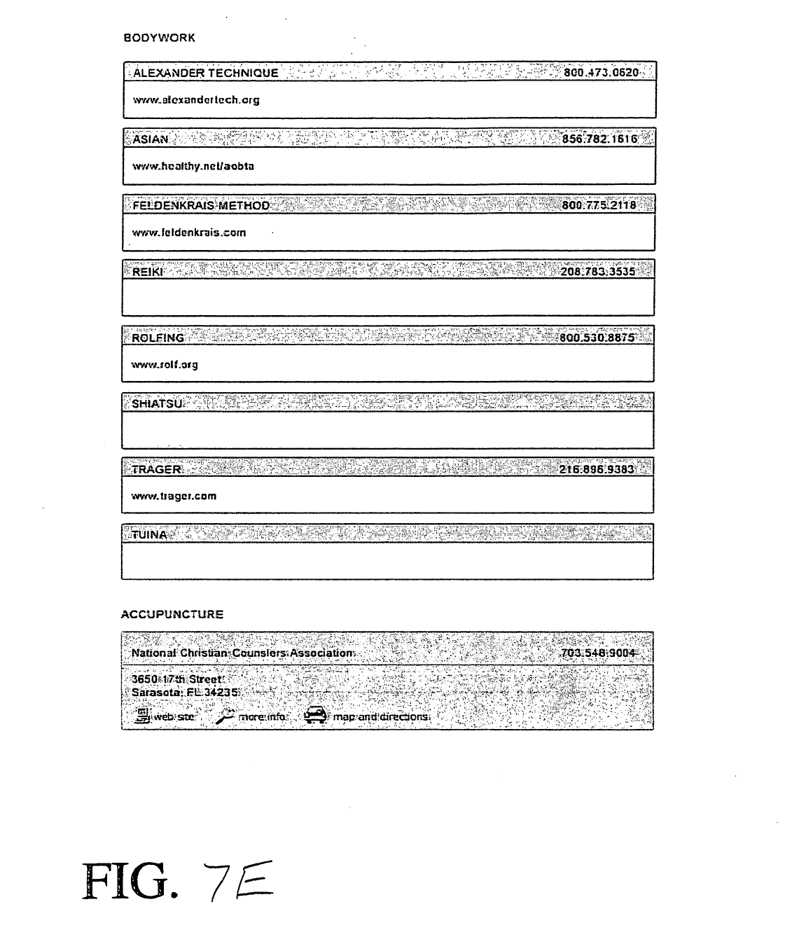

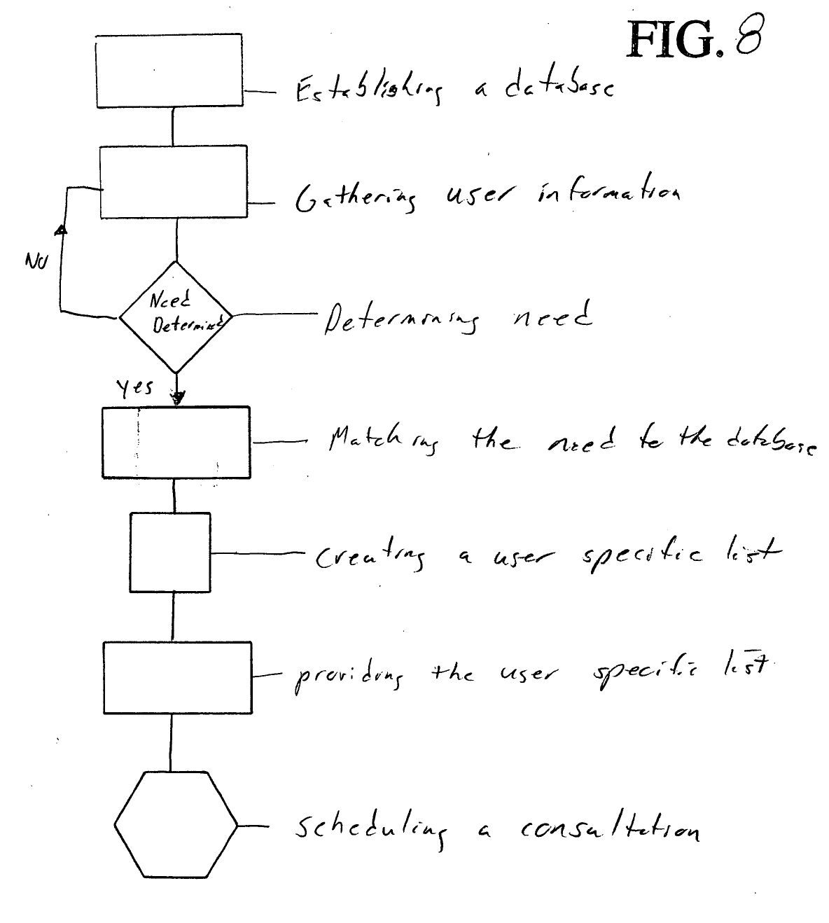

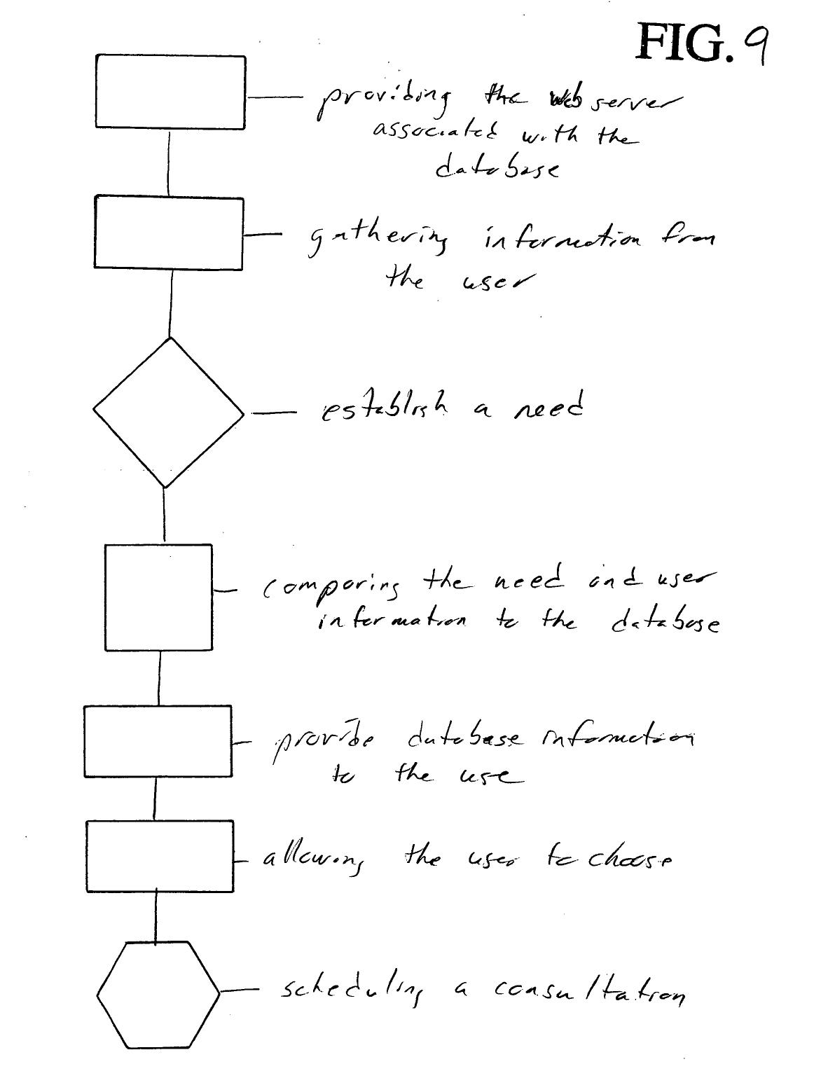

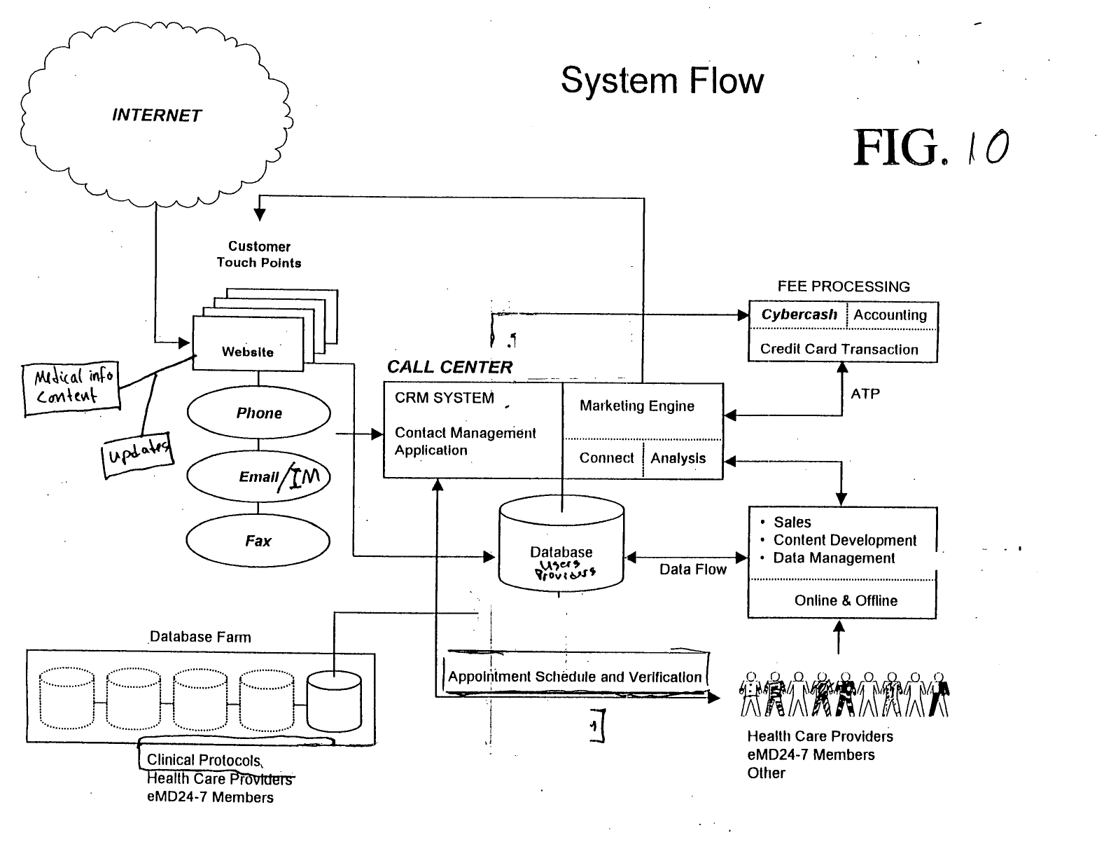

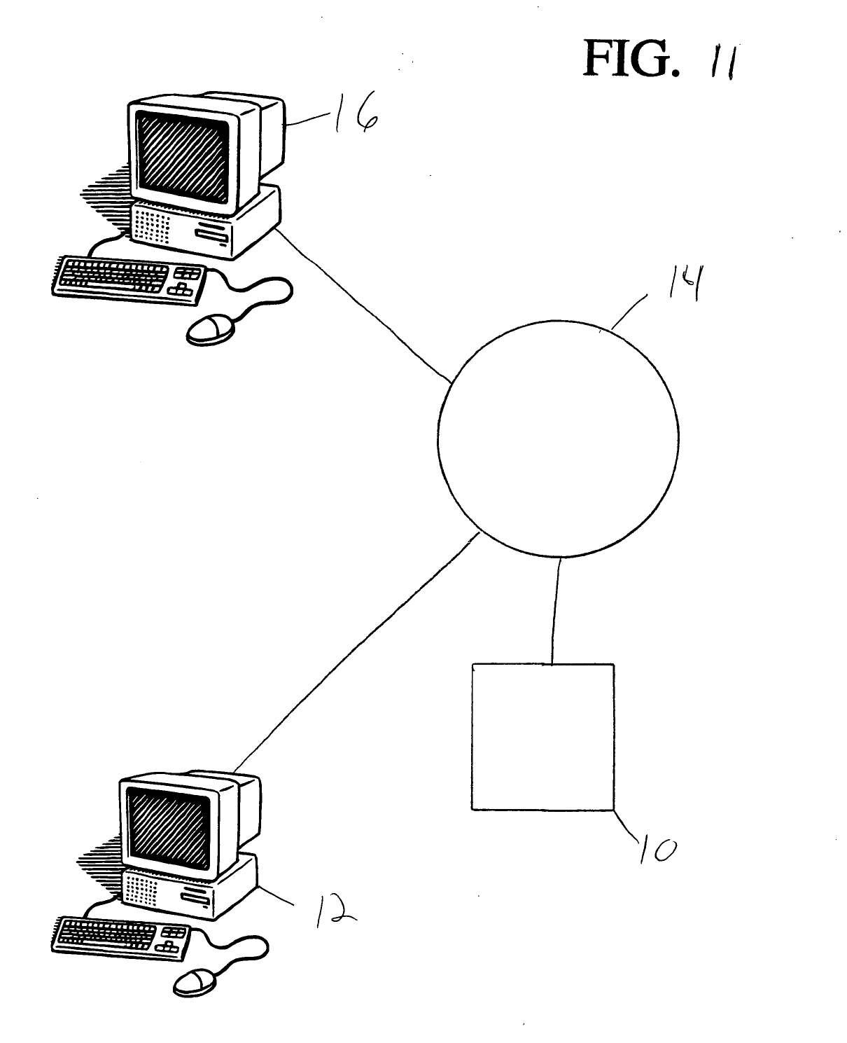

An additional feature of the current invention includes the interactive resource locator, as exampled in FIGS. 5A-7E. This allows a user of the system to locate specific service and product providers given the symptom criteria as well as additional user specific criteria, such a geographical location, language proficiency, and the like.

As the user navigates through the informational contents the system can track items of interest to the user. In the resource locator, the user can choose various provider categories in which he/she is interested in. These categories can include basic self-help measures, specific medical specialists, alternative medical options and the like. Under this system, some of the categories have been pre-selected by the user tracking feature. The user can then choose between gathering assistance from call center nurse, scheduling an appointment, or accessing additional information on the providers he/she chooses. Live, real time, communication may occur between users and call center personnel by multiple mechanisms including electronic chatting, instant messaging, telephone and the like.

The database, hardware, software, and call center function of the current invention are capable of connecting to the scheduling systems of the providers chosen by the user and allow the user to establish an appointment, schedule a visit with or order products from the user selected health care or wellness provider. This system can also be configured to send a confirming correspondence to the user indicating the scheduled appoint has been set. This confirmation can be through various means, such as electronic mail, telephone, and standard mail. The system can also be configured to request an earnest money payment from the user of the system to reduce the amount of missed appointments by the users of the system.

If the user chooses to access the call center, a specially trained person can communicate with the user either online or by telephone and can gather information that can define the nature, scope, and acuity of the problem, collect additional information from the user that can then be supplied to the healthcare provider, discuss and recommend additional options for care among appropriate provider categories, and schedule appointments. The call center personnel can also follow-up with a confirming correspondence with the user of the transaction including what was discussed and any appointments established through the use of electronic mail, regular mail, telephone, or the like.

Additional features of the current invention include the capacity to review various databases having healthcare and wellness information as well as service and product provider information. The invention can connect to multiple provider types as well as allow multi-criteria search capabilities covering various health and wellness issues as well as user driven healthcare choices.

Other options are also included. For example, a specific user's insurance or medical payment can be confirmed, allowing direct knowledge to the user of which healthcare providers are covered under which payment systems, insurance carriers and the like. The feature of the commitment deposit, or payment by the user of the system as he/she chooses and commits to a scheduled appointment, reduces the amount of no shows and ghost appointments for the healthcare provider. Also included can be specific information on healthcare providers including video clips, audio clips, and written literature. Patient satisfaction surveys and comments on specific healthcare providers can also increase the amount of information given to users of the system for various healthcare and wellness providers. The system can be designed to operate in a multi-language capacity and provide follow-up correspondence from the system to the various users of the system to ensure that the healthcare and wellness issues and concerns that they had have been addressed.

An example of a navigational system for providing health-related information to and scheduling services for a user of the internet is shown generally in FIG. 11. The web server 10 contains a database of healthcare-related information a user at his or her computer 12 can access through the internet 14 the web pages supported by the web server 10. The user's computer 12 can interact with the web server 10 to establish a health-related need. The user can also obtain healthcare-related information specific to the healthcare-related need of the user. The system can then use the internet 14 to access the service provider system 16 to establish a consultation between the user's computer 12 and the scheduling software of the service provider 16.

Thus, although there have been described particular embodiments of the present invention of a new and useful Web Based Health and Wellness Resource Locator, it is not intended that such references be construed as limitations upon the scope of this invention except as set forth in the following claims.

What is claimed is:

1. A method of providing healthcare related information to a user comprising:
a) establishing a database of health related service providers;
b) gathering information from the user;
c) processing the information to determine a health related need;
d) matching the heath related need to the database of health related service providers and creating a user specific list of health related service providers;
e) providing the list of health related service providers to the user;
f) allowing the user to select a specific health related service provider; and
g) scheduling a consultation between the user and the specific health related service provider.

2. The method of claim 1, wherein step b) further includes using interactive software to gather the user's health related information, the user's geographical information, and the user's preference information.

3. The method of claim 2, wherein step b) the gathering of user preference information further includes the gathering of the user's language preference, user's insurance coverage, and user's gender preference.

4. The method of claim 1, wherein step c) further include using interactive software to process the information to determine the health related need.

5. The method of claim 1, wherein steps b), c), d), e), f, and g) are performed using the Internet.

6. The method of claim 5, wherein steps c), d), e), and g) are performed by a real time interaction by the user and the database of health related service providers.

7. The method of claim 1, wherein step g) further includes establishing an appointment with the health related service provider.

8. The method of claim 1, wherein step g) further includes ordering products from the health related service provider.

9. A method utilizing the Internet to provide a user with healthcare related information and establish a consultation between the user and a healthcare related service provider, the method comprising:
a) providing a web server associated with the database of health related service providers;
b) allowing the user to access web pages supported by the web browser;
c) using interactive software to establish a user directed health related need and to gather user specific information;
d) providing the user with healthcare related information corresponding with the health related need;
e) creating a user specific list of health related service providers by comparing the heath related need and the user specific information to the database of health related service providers;
f) allowing the user to select a specific health related service provider from the user specific list of health related service providers; and
g) scheduling a consultation between the user and one of the specific health related service providers from the user specific list of health related service providers.

10. The method of claim 9, wherein step c) further includes using a substantially anatomically correct human image to establish the user directed health related need.

11. The method of claim 9, wherein in step c) the user specific information gathered includes the users' symptoms, the user's age, the user's gender, and the user's geographical location.

12. The method of claim 9, wherein the database of health related service providers includes traditional medicine providers and non-traditional alternative therapies.

13. The method of claim 12, wherein the traditional medicine providers and non-traditional alternative therapies includes doctors, nutritionists, therapists, counselors, trainers, health device suppliers, pharmacists, gymnasiums, acupuncturist, and holistic medicine providers.

14. The method of claim 9, wherein step g) further includes accessing a computer based scheduling system of the specific health related service provider and reserving a consultation between the user and the specific health related service provider.

15. The method of claim 14, wherein step g) further includes obtaining a consultation deposit from the user.

16. The method of claim 9, further including:
h) using a contact center to answer questions from the user.

17. The method of claim 9, further including:
h) determining the user's medical insurance coverage.

18. The method of claim 9, wherein step f) further includes providing the user with service provider information on the health related service providers on the user specific list of health related service providers.

19. A navigational system for providing health related information to and scheduling services for a user of the Internet, the system comprising:
a web server contain a database of healthcare related information, the data base including a listing of healthcare related service providers, service provider information specific to each of the healthcare related service providers, and healthcare related information specific to a plurality of healthcare related needs;
a retrieval system accessible by the user of the Internet, the retrieval system including an interactive interface between the user of the Internet and the web server;
a scheduling system interfacing the user of the Internet and at least one of the healthcare related service providers to establish a consultation between the user of the Internet and at least one of the healthcare related service providers.

20. The navigational system of claim 19, wherein the retrieval system collects user specific information and provides the health related information to the user.
